(19) United States
(12) Patent Application Publication
(10) Pub. No.: US 2024/0371048 A1
(43) Pub. Date: Nov. 7, 2024

(54) ABSTRACT BACKGROUND GENERATION

(71) Applicant: ADOBE INC., SAN JOSE, CA (US)

(72) Inventors: Hareesh Ravi, San Jose, CA (US); Ajinkya Gorakhnath Kale, San Jose, CA (US)

(21) Appl. No.: 18/312,246

(22) Filed: May 4, 2023

(51) Int. Cl. G06T 11/00; G06N 3/0475; G06N 3/094

(52) U.S. Cl. CPC G06T 11/00; G06N 3/0475; G06N 3/094

(57) ABSTRACT

Systems and methods for generating abstract backgrounds are described. Embodiments are configured to obtain an input prompt, encode the input prompt to obtain a prompt embedding, and generate a latent vector based on the prompt embedding and a noise vector. Embodiments include a multimodal encoder configured to generate the prompt embedding, which is an intermediate representation the prompt. In some cases, the prompt includes or indicates an “abstract background” type image. The latent vector is generated using a mapping network of a generative adversarial network (GAN). Embodiments are further configured to generate an image based on the latent vector using the GAN.

### BACKGROUND

The following relates to image processing, and in some embodiments, to image generation for abstract patterns. Image processing refers to the use of a computer to process a digital image using an algorithm or processing network. Examples of image processing include image enhancement, brightness and contrast adjustments, and color grading. Further examples include generating new image content, such as inpainting and conditional generation of new images. Recently, machine learning (ML) models have been developed that are capable of producing detailed high-resolution images. Generative Adversarial Networks (GANs), for instance, have been used to generate images, video, and even music.

During training, GANs use two neural networks, a generator and a discriminator, which compete against each other to improve the quality of generated images. After training, the discriminator is removed from the model, and the trained generator is configured to generate new images. One of the challenges with GANs is ensuring that the generated images are diverse and not just reproductions of the training dataset. GANs can suffer from mode collapse, which causes the model to generate the same images repeatedly. This is especially prevalent in areas such as abstract images. There is a need in the art for a model that generates diverse images while retaining the benefits of GANs such as their editing capabilities and fast inference times.

### SUMMARY

Embodiments of an image generation system are described herein. Some embodiments of the image generation system include a multimodal encoder and a GAN. According to some aspects, the GAN is trained in a process that includes embeddings from the multimodal encoder such that a latent space of the GAN produces diverse abstract images when acted on by a generator of the GAN. In an example, the system obtains an input prompt from a user. The system then encodes the input prompt using the multimodal encoder to obtain a prompt embedding. The system generates a latent vector based on the prompt embedding and a noise vector using a mapping network of the GAN. Lastly, the system generates an image based on the latent vector using the GAN.

A method, apparatus, non-transitory computer readable medium, and system for image generation are described. One or more aspects of the method, apparatus, non-transitory computer readable medium, and system include obtaining an input prompt; encoding the input prompt to obtain a prompt embedding; generating a latent vector based on the prompt embedding and a noise vector using a mapping network of a generative adversarial network (GAN); and generating an image based on the latent vector using the GAN.

A method, apparatus, non-transitory computer readable medium, and system for image generation are described. One or more aspects of the method, apparatus, non-transitory computer readable medium, and system include obtaining a training image; encoding the training image to obtain an image embedding; generating a latent vector for a generative adversarial network (GAN) based on the image embedding using a mapping network; and training the GAN to generate an output image based on the latent vector using a discriminator network.

An apparatus, system, and method for image generation are described. One or more aspects of the apparatus, system, and method include at least one processor; at least one memory storing instructions executable by the processor; and a generative adversarial network (GAN) comprising parameters stored in the at least one memory, wherein the GAN is trained to generate a latent vector based on an image embedding and a noise vector, and to generate an output image based on the latent vector.

### BRIEF DESCRIPTION OF THE DRAWINGS

FIG. 1 shows an example of an image generation system according to aspects of the present disclosure.

FIG. 2 shows an example of an image generation apparatus according to aspects of the present disclosure.

FIG. 3 shows an example of a mapping network and a generator network according to aspects of the present disclosure.

FIG. 4A shows an example of an architecture of the GAN prompted with a text prompt at inference time according to aspects of the present disclosure.

FIG. 4B shows an example of an architecture of the GAN prompted with an image prompt at inference time according to aspects of the present disclosure.

FIG. 5 shows an example of a method for using the image generation system according to aspects of the present disclosure.

FIG. 6 shows an example of a method for generating an image according to aspects of the present disclosure.

FIG. 7 shows an example of a method for editing an input image according to aspects of the present disclosure.

FIG. 8 shows an example of an architecture of the GAN during training according to aspects of the present disclosure.

FIG. 9 shows an example of a method for training a generative image model according to aspects of the present disclosure.

FIG. 10 shows an example of a method for image processing according to aspects of the present disclosure.

FIG. 11 shows an example of a computing device according to aspects of the present disclosure.

### DETAILED DESCRIPTION

Recently, researchers and creators have applied machine learning (ML) models to the task of image synthesis and generation. Three major groups of generative models used to obtain detailed and high-resolution images are GAN models, transformer based models, and diffusion models.

Transformer based models are able to generate high quality and diverse images, but they can take a relatively long time to produce images during inference. Furthermore, the embeddings that are used to produce the images through decoding processes do not provide editability. Diffusion based models can also suffer from long inference times, though recent developments in diffusion architecture have sought to address this. Still, diffusion models also do not provide a latent space with extensive editability.

GANs are a type of machine learning model used to generate data, such as image data, that has the same realistic properties and features of the data used during training. To accomplish this, GANs include both a generator network and a discriminator network during training. The generator network generates new images, while the discriminator network tries to distinguish between the generated images and real images from a dataset. Through an iterative process of training, the generator improves its ability to generate realistic images that can fool the discriminator, while the discriminator improves its ability to distinguish between the generated and real images. The result is a generator that can produce new images that are similar to the ones in the training dataset.

StyleGAN is a variation of the GAN architecture that introduces a type of style space that disentangles style attributes from the images. During training, StyleGAN learns automatic, unsupervised separation of high-level attributes that can be edited in an intermediate space without losing the “identity” of a subject or content in the image. In this way, various style attributes of an image such as “age”, “pose”, and “smile”, etc. can be edited in the intermediate space by first inverting an image into the intermediate space as an intermediate vector, moving the intermediate vector in the “direction” of the attribute, and then re-generating the image from the intermediate vector.

GAN models and variations of GAN models can suffer from mode collapse, wherein their generators produce a limited range of outputs that do not capture the full diversity of the training data. In other words, the generator generates only a few modes or patterns, resulting in repetitive and unrealistic generated samples. One reason that GANs may do this is because, during training, the generator network may exploit certain shortcuts to achieve high performance without truly modeling the underlying distribution of the data. Another reason is that, if the discriminator is too strong, the generator may focus its learning on a limited set of outputs that are more difficult for the discriminator.

GAN models are conventionally trained by providing class information along with noise as input to the model. The class information helps the model generate images that pertain to a particular class. Class labels may be specific identifiers that are assigned to individual images based on class information of the subject matter or content of the images. For example, an image of a cat might be labeled as “cat”, while an image of a dog might be labeled as “dog”. In some cases, class labels used to train the GAN models may be associated with concrete objects or animals, rather than abstract concepts or visual features. This creates challenges for generating images lacking well-defined subject matter or content, including abstract images. In the case of abstract images, using class labels corresponding to subject matter or content that is not well-defined or concrete may not capture the full range of variation present within that class. For example, a class label such as “abstract backgrounds” does not capture the wide variance across all abstract-like images in the training data. This causes the standard GANs and StyleGANs to not learn the variance, resulting in mode collapse.

Embodiments of the present disclosure include a multimodal encoder which generates an embedding for each training image. In contrast to class-conditional information, which is limited to a small number of labels or categories, the image embeddings generated by the multimodal encoder may capture a richer and more diverse set of features that are associated with each training image. The set of features may be used to condition a generator and a discriminator. For example, by incorporating image embeddings obtained from a pre-trained CLIP model, the generator and discriminator can be trained to produce high-quality and diverse abstract images, with greater control over the conditioning information used to guide the generation process. Accordingly, embodiments of the present disclosure can escape mode collapse and are able to generate a diverse variety of abstract background images. Embodiments are not restricted to any one type of subject matter during training, however, and may be trained to generate diverse images in many domains. Furthermore, since embodiments include a multimodal encoder, users may provide text or image prompts to generate novel images that include the subject matter of the prompt.

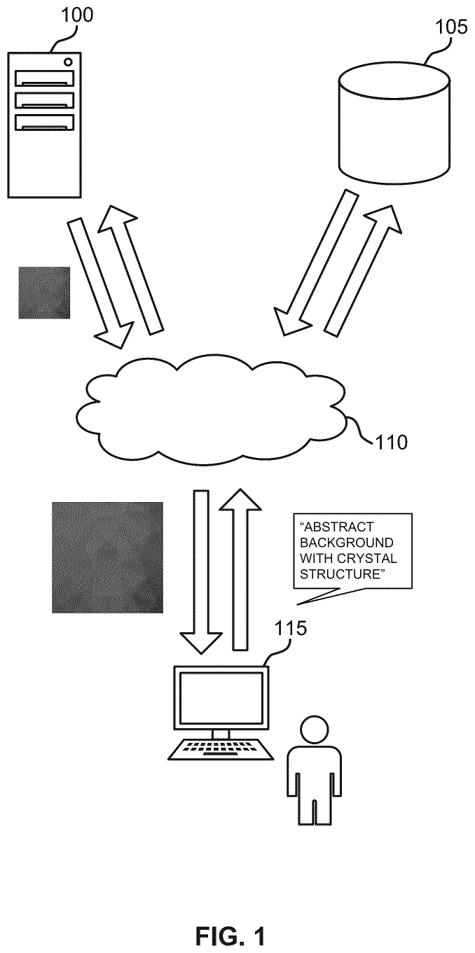

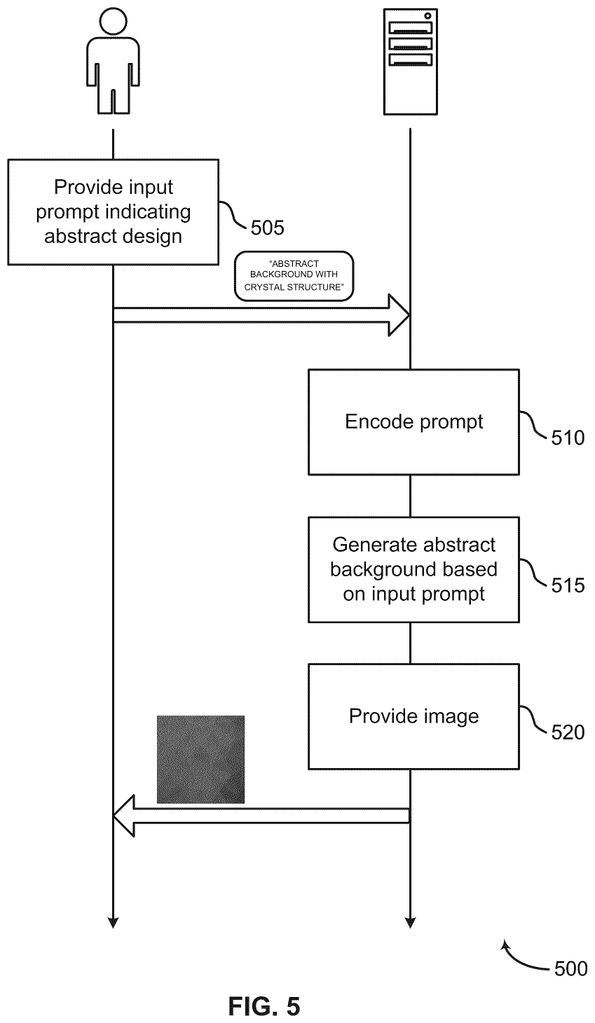

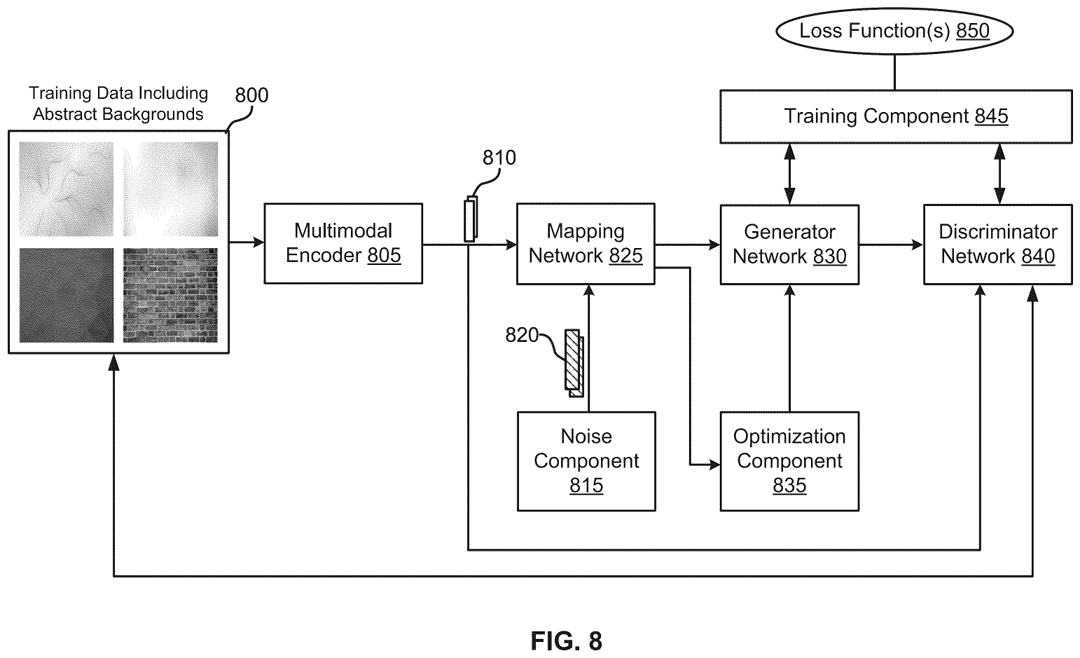

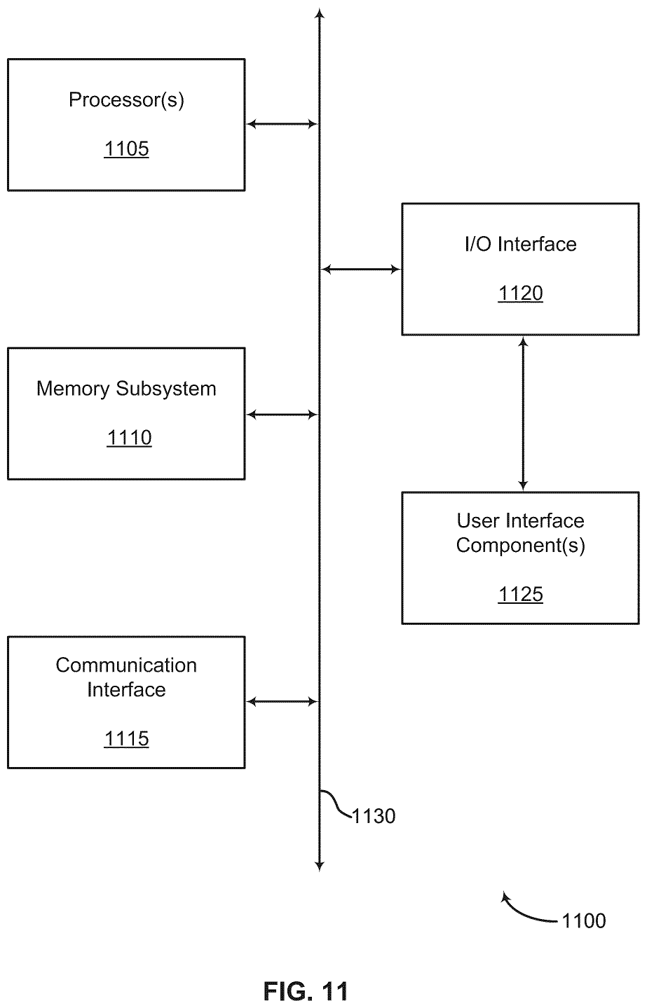

An image generation system is described with reference to FIGS. 1-4. Methods for generating images including abstract background images are described with reference to FIGS. 5-7. Initialization and training methods are described with reference to FIGS. 8-10. A computing device configured to implement an image generation apparatus is described with reference to FIG. 11.

### Image Generation System

An apparatus for image generation is described. One or more aspects of the apparatus include at least one processor; at least one memory storing instructions executable by the processor; and a GAN comprising parameters stored in the at least one memory, wherein the GAN is trained to generate a latent vector based on an image embedding and a noise vector, and to generate an output image based on the latent vector.

In some aspects, the GAN comprises a mapping network and a generator network, wherein the mapping network is configured to generate the latent vector for input to the generator network. Some examples further include an optimization component configured to tune the GAN using the latent vector as a pivot for a latent space of the GAN. Some examples of the apparatus, system, and method further include a multimodal encoder configured to generate the image embedding based on an input image or an input text.

Some examples of the apparatus, system, and method further include a discriminator network configured to classify an output of the GAN. Some examples further include a training component configured to train the GAN using a reconstruction loss based on the output image.

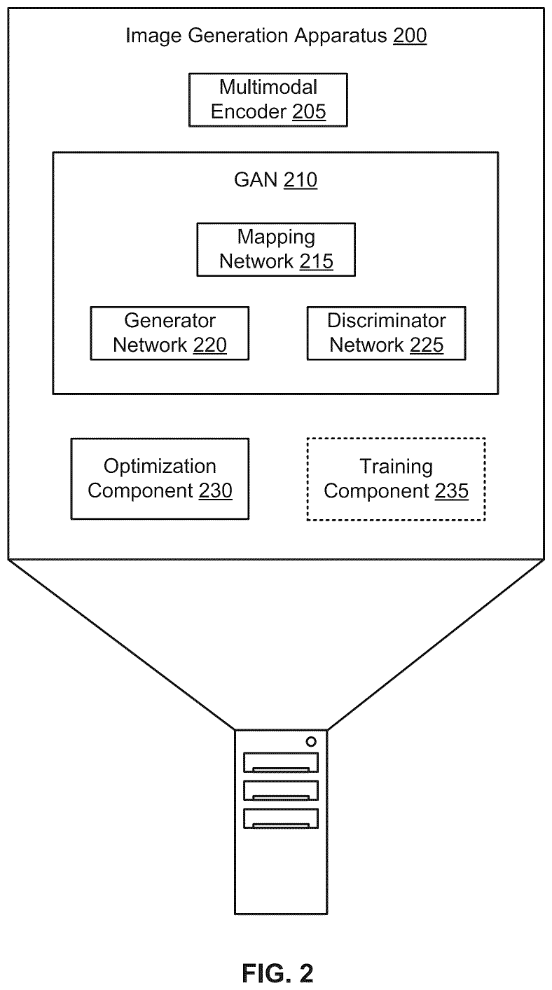

FIG. 1 shows an example of an image generation system according to aspects of the present disclosure. The example shown includes image generation apparatus 100, database 105, network 110, and user interface 115. Image generation apparatus 100 is an example of, or includes aspects of, the corresponding element described with reference to FIG. 2.

In one example, a user provides a prompt via user interface 115 that indicates an abstract design. The prompt can be a text prompt, or a “starter image” prompt, for example. Then, network 110 passes the prompt information to image generation apparatus 100, which processes the prompt to generate an abstract image. In some cases, image generation apparatus 100 includes a trained generative model, and parameters of the model are stored in database 105.

The input prompt can include different modalities of information. In some aspects, the prompt includes a text prompt describing an abstract design, and the generated image includes the abstract design. In some aspects, the prompt includes an image depicting a version of an abstract design, and the generated image includes the abstract design. In some aspects, the input prompt includes an original image including an abstract design and text describing a modification to the original image, where the generated image includes the modification to the original image. In some aspects, the input prompt includes an original image and text describing an abstract design.

Embodiments of image generation apparatus 100 or portions of image generation apparatus 100 can be implemented on a server. A server provides one or more functions to users linked by way of one or more of the various networks 110. In some cases, the server includes a single microprocessor board, which includes a microprocessor responsible for controlling all aspects of the server. In some cases, a server uses microprocessor and protocols to exchange data with other devices/users on one or more of the networks 110 via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Various data used by the image generation system are stored in database 105. For example, trained model parameters of image generation apparatus 100 or image datasets used to train image generation 100 may be stored in database 105. In some cases, database 105 includes data storage, as well as a server to manage disbursement of data and content. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image generation apparatus 100, database 105, and user interface 115 (e.g., to a user). Network 110 can be referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 is configured to receive commands from and present content to a user. For example, a user may enter a prompt, select configurations or edits, or view images via user interface 115. Embodiments of user interface 115 include a display, input means such as a mouse and keyboard or touch screen, speakers, and the like.

FIG. 2 shows an example of an image generation apparatus 200 according to aspects of the present disclosure. The example shown includes image generation apparatus 200, multimodal encoder 205, GAN 210, optimization component 230, and training component 235. Image generation apparatus 200 is an example of, or includes aspects of, the corresponding element described with reference to FIG. 1.

Embodiments of image generation apparatus 200 include several components. The term ‘component’ is used to partition the functionality enabled by the processor(s) and the executable instructions included in the computing device used to implement image generation apparatus 200 (such as the computing device described with reference to FIG. 11). The partitions may be implemented physically, such as through the use of separate circuits or processors for each component, or may be implemented logically via the architecture of the code executable by the processors.

According to some aspects, multimodal encoder 205 encodes the input prompt to obtain a prompt embedding. According to some aspects, multimodal encoder 205 is configured to generate the image embedding based on an input image or an input text.

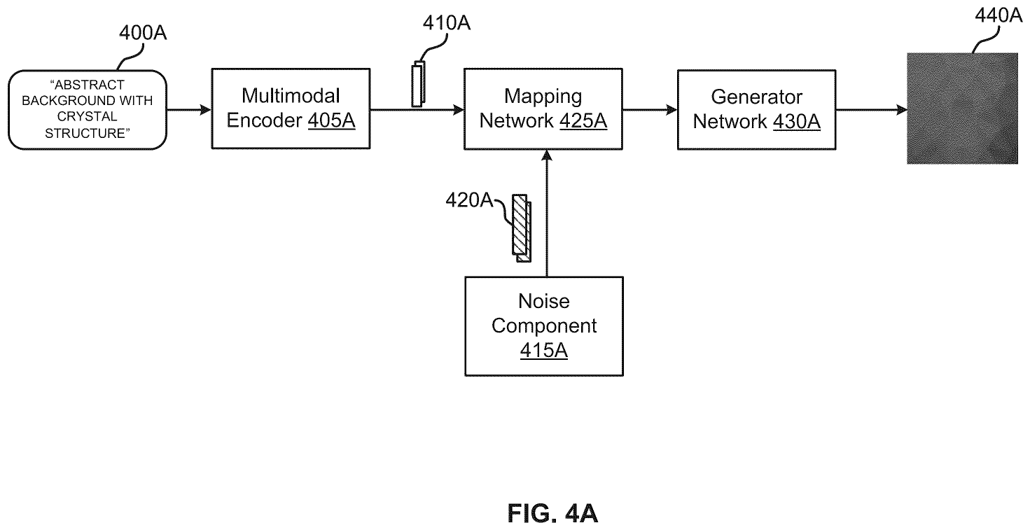

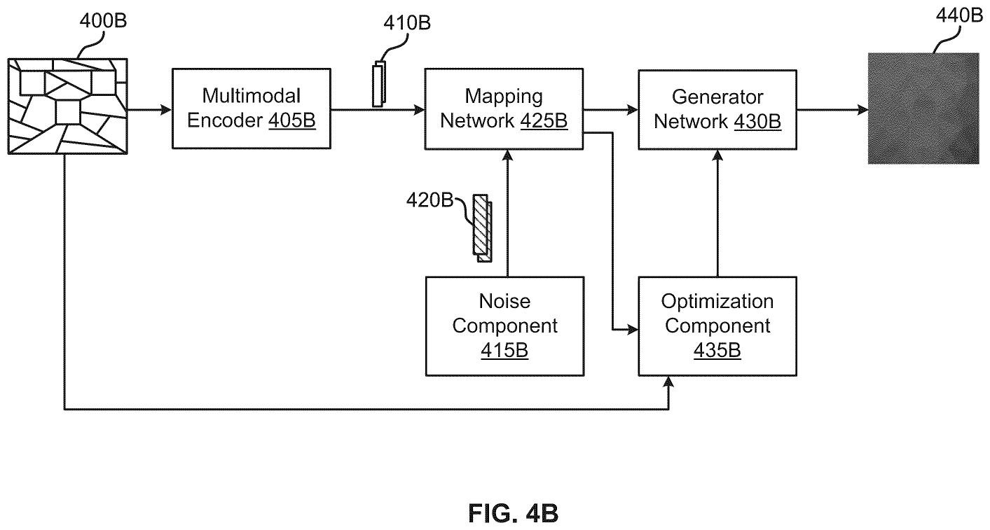

According to some aspects, multimodal encoder 205 encodes a training image from a training dataset to obtain an image embedding. In some examples, the image embedding is used to condition generator network 220 or discriminator network 225 during a training phase. Multimodal encoder 205 is an example of, or includes aspects of, the corresponding element described with reference to FIGS. 4 and 8. In some embodiments, multimodal encoder 205 is a language based encoder, and is pre-trained to correspond language information to visual information. In at least one embodiment, multimodal encoder 205 includes aspects of the CLIP (Contrastive Language-Image Pre-Training) network. CLIP is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets.

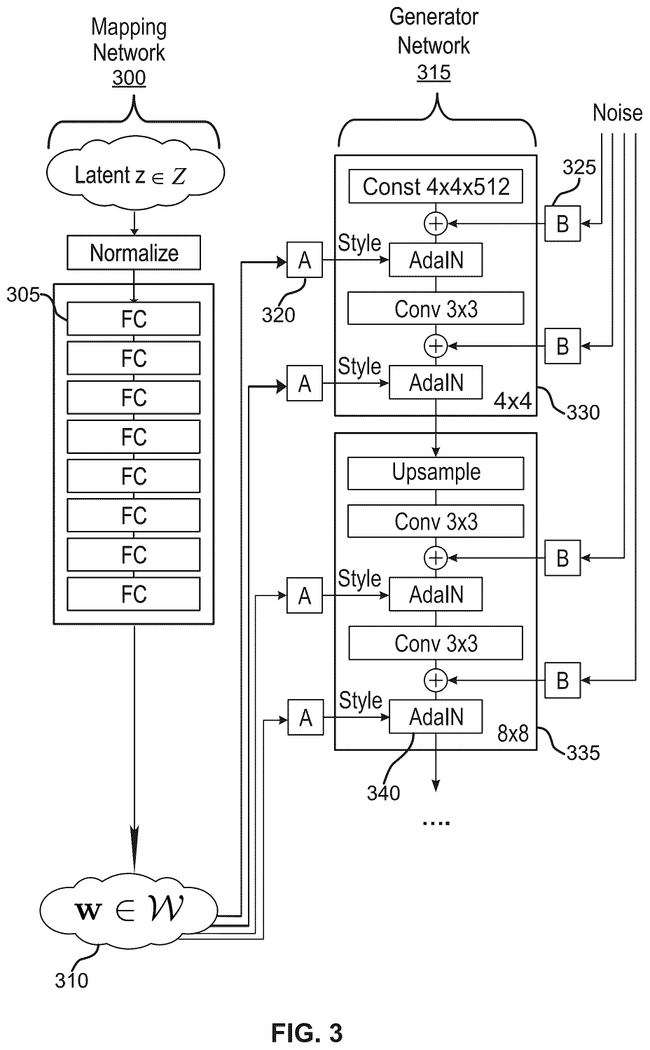

In one aspect, GAN 210 includes mapping network 215, generator network 220, and discriminator network 225. Additional detail regarding an example of mapping network 215 and generator network 220 will be provided with reference to FIG. 3. Additional detail regarding an example of discriminator network 225 will be provided with reference to FIG. 8. According to some aspects, GAN 210 generates an image based on a latent vector from mapping network 215. In some aspects, the GAN 210 is trained to generate abstract images based on conditioning from abstract image embeddings.

Conventional GANs include a mapping network to map a noise vector from a lower dimensional space to a higher dimensional space to be used as input to a generator network. According to some aspects, mapping network 215 of the present disclosure generates a latent vector based on a noise vector as well as a prompt embedding. Mapping network 215 may be or include aspects of a style-based generative model such as StyleGAN. For example, embodiments of mapping network 215 may produce a latent vector with a structure that is based on various attributes of the image to facilitate editing downstream. Mapping network 215 is an example of, or includes aspects of, the corresponding element described with reference to FIGS. 3, 4, and 8.

Generator network 220 is configured to generate new images that are similar to images seen during training. Some embodiments of generator network 220 include progressive growing layers, which produce images in progressively larger resolutions (2×2, 4×4, 512×512, etc.) to learn finer detail. Generator network 220 is an example of, or includes aspects of, the corresponding element described with reference to FIGS. 3, 4, and 8.

Discriminator network 225 evaluates images produced by generator network 220 during training. In some embodiments, discriminator network 225 includes multiple discriminators that are configured to discriminate the data produced by generator network 220 on different bases. For example, one discriminator may evaluate images based on their adherence to the original “identity” of an image, another may evaluate coarse features, fine features, etc. Discriminator network 225 is an example of, or includes aspects of, the corresponding element described with reference to FIG. 8.

Optimization component 230 is configured to adjust a latent space within generator network 220 according to a process known as Pivotal Tuning Inversion (PTI). According to some aspects, optimization component 230 performs an image inversion by tuning the GAN 210 using the latent vector as a pivot for a latent space of the GAN 210. In some embodiments, optimization component 230 uses the embedding produced by multimodal encoder 205 alone as the pivot for a latent space of the GAN 210. Optimization component 230 is an example of, or includes aspects of, the corresponding element described with reference to FIGS. 4 and 8. Additional detail regarding the PTI process will be provided with reference to FIG. 4.

Training component 235 is configured to adjust parameters of GAN 210 during a training process. Training component 235 is configured to compute a loss function, and then adjust parameters of the entire network according to a process known as backpropagation. According to some aspects, one or more parameters of GAN 210 may be held fixed while others are adjusted during different training phases.

According to some aspects, training component 235 trains GAN 210 to generate a latent vector based on the image embedding and a noise vector, and to generate an output image based on the latent vector. In some examples, discriminator network 225 classifies an output image of generator network 220, and training component 235 computes a discriminator loss based on the classification. GAN 210 is then trained based on the discriminator loss. In some examples, training component 235 computes a reconstruction loss based on an abstract image from a training dataset and the output image, where the GAN 210 is trained based on the reconstruction loss. In some aspects, the reconstruction loss includes a pixel-based loss term and a perceptual loss term. In some examples, training component 235 trains the GAN 210 during a first phase without the reconstruction loss. In some examples, training component 235 trains the GAN 210 during a second phase using the reconstruction loss, where the second phase trains high resolution layers of the GAN 210 and the first phase trains low resolution layers of the GAN 210.

Training component 235 is an example of, or includes aspects of, the corresponding element described with reference to FIG. 8. In at least one embodiment, training component 235 is provided in an apparatus different from image generation apparatus 200.

FIG. 3 shows an example of a mapping network 300 and a generator network 315 according to aspects of the present disclosure. The example shown includes mapping network 300, fully connected layer 305, intermediate latent space 310, generator network 315, learned affine transform 320, learned per-layer scaling factors 325, first convolutional layer 330, second convolutional layer 335, and adaptive instance normalization 340. Mapping network 300 is an example of, or includes aspects of, the corresponding element described with reference to FIGS. 2, 4, and 8. Generator network 315 is an example of, or includes aspects of, the corresponding element described with reference to FIGS. 2, 4, and 8.

In an example GAN, a generator network generates candidate data, such as images, while a discriminator network evaluates them. The generator network learns to map from a latent space to a data distribution of interest, while the discriminator network distinguishes candidates produced by the generator from the true data distribution. The generator network's training objective is to increase the error rate of the discriminator network, i.e., to produce novel candidates that the discriminator network classifies as real.

In an example process, mapping network 300 performs a reduced encoding of the original input and the generator network 315 generates, from the reduced encoding, a representation as close as possible to the original input. According to some embodiments, the mapping network 300 includes a deep learning neural network comprised of fully connected layers (e.g., fully connected layer 305). In some cases, the mapping network 300 takes a randomly sampled point from the latent space, such as intermediate latent space 310, as input and generates a latent vector as output. In some cases, the latent vector encodes style attributes.

According to some embodiments, the generator network 315 includes a first convolutional layer 330 and a second convolutional layer 335. For example, the first convolutional layer 330 includes convolutional layers, such as a conv 3×3, adaptive instance normalization (AdaIN) layers, or a constant, such as a 4×4×512 constant value. For example, the second convolutional layer 305 includes an upsampling layer (e.g., upsample), convolutional layers (e.g., conv 3×3), and adaptive instance normalization (AdaIN) layers.

The generator network 315 takes a constant value, for example, a constant 4×4×512 constant value, as input to start the image synthesis process. The latent vector generated from the mapping network 300 is transformed by learned affine transform 320 and is incorporated into each block of the generator network 315 after the convolutional layers (e.g., conv 3×3) via the AdaIN operation, such as adaptive instance normalization 340. In some cases, the adaptive instance normalization layers can perform the adaptive instance normalization 340. The AdaIN layers first standardizes the output of feature map so that the latent space maps to features in a way so that a randomly selected feature map will result in features that are distributed with a Gaussian distribution, then add the latent vector as a bias term. This allows choosing a random latent variable and so that the resulting output will not bunch up. In some cases, the output of each convolutional layer (e.g., conv 3×3) in the generator network 315 is a block of activation maps. In some cases, the upsampling layer doubles the dimensions of input (e.g., from 4×4 to 8×8) and is followed by another convolutional layer(s) (e.g., third convolutional layer).

According to some embodiments, Gaussian noise is added to each of these activation maps prior to the adaptive instance normalization 340. A different noise sample is generated for each block and is interpreted using learned per-layer scaling factors 325. In some embodiments, the Gaussian noise introduces style-level variation at a given level of detail.

FIG. 4A shows an example of an architecture of the GAN prompted with a text prompt at inference time according to aspects of the present disclosure. The example shown includes input prompt 400A, multimodal encoder 405A, prompt embedding 410A, noise component 415A, noise vector 420A, mapping network 425A, generator network 430A, and generated image 440A.

Multimodal encoder 405A is an example of, or includes aspects of, the corresponding element described with reference to FIGS. 2 and 8. Noise component 415A is an example of, or includes aspects of, the corresponding element described with reference to FIG. 8.

Mapping network 425A is an example of, or includes aspects of, the corresponding element described with reference to FIGS. 2, 3, and 8. Generator network 430A is an example of, or includes aspects of, the corresponding element described with reference to FIGS. 2, 3, and 8. In some cases, the mapping network 425A takes as input a prompt embedding and noise vector and generates a latent vector used for image generation. In some cases, the mapping network 425A may be a fully connected neural network with layers that learn to map the input noise and prompt embedding to a high-dimensional latent space.

The example shown in FIG. 4A provides a pipeline for generating abstract background images according to the present disclosure. In the example shown, the system obtains an input text as input prompt 400A. In this example, input prompt 400A is a text provided by a user. The system encodes the text using multimodal encoder 405A.

Then, multimodal encoder 405A encodes input prompt 400A to produce prompt embedding 410A. Prompt embedding 410A is a representation of input prompt 400A in an embedding space. Embodiments of multimodal encoder 405A include a language-based encoder that is trained to produce similar representations for an image and for a text describing the image. The multimodal encoder 405A may generate embeddings for a wide range of inputs, including text, images, and other modalities. In some examples, a user might provide a textual description of an abstract background image they want to generate, such as “abstract background with crystal structure”. The multimodal encoder 405A can then use a CLIP model to generate an embedding that represents visual features associated with this textual description. In some cases, a user might upload an abstract background image, and the multimodal encoder 405A may use the abstract background image to generate an embedding that captures the specific abstract background characteristics of that image. An example of a case in which the user uploads an image, rather than a text, is described with reference to FIG. 4B. An example of using multimodal encoder 405A during training of the overall model will be described with reference to FIG. 8.

In some embodiments, multimodal encoder 405A includes functionality to identify an image embedding corresponding to the textual prompt embedding in the multimodal embedding space. The multimodal encoder may include one or more layers (e.g., linear layers) that process a text prompt embedding from a text embedding cluster in the multimodal embedding space to determine a corresponding image embedding in an image embedding cluster in the multimodal embedding space. In some examples, the corresponding image embedding is used as prompt embedding 410A, rather than the initial text embedding generated from input prompt 400A. In some cases, using the corresponding image embedding provides improved image generation from the GAN, as embodiments of the GAN are trained on image embeddings during the training process.

Noise component 415A generates noise vector 420A. In some embodiments, noise vector 420A includes random or Gaussian noise. In some embodiments, noise vector 420A is of the same dimensionality as prompt embedding 410A. In some embodiments, noise vector 420A has a different dimensionality from prompt embedding 410A, and they are combined into a single vector of a third dimensionality before being input to mapping network 425A. Noise vector 420A provides stochasticity during the generation, so that the output isn't too close to the features contained in prompt embedding 410A.

Mapping network 425A uses prompt embedding 410A and noise vector 420A as bases to generate a latent vector used for image generation. For example, mapping network 425A generates the latent vector using a fully connected network such as the one described with reference to FIG. 3. The latent vector includes context from prompt embedding 410A and variation from noise vector 420A.

Generator network 430A generates generated image 440A by transforming the latent vector from a latent space into pixel data. Embodiments of generator network 430A include various AdaIN, convolutional, and upsampling layers that, in combination, are configured to apply a series of learned transformations to the latent code.

FIG. 4B shows an example of an architecture of the GAN prompted with an image prompt at inference time according to aspects of the present disclosure. The example shown includes input prompt 400B, multimodal encoder 405B, prompt embedding 410B, noise component 415B, noise vector 420A, mapping network 425B, generator network 430B, optimization component 435B, and generated image 440B.

FIG. 4B, similar to FIG. 4A, provides a pipeline for generating abstract background images according to the present disclosure. However, FIG. 4B includes an input image prompt 400B rather than a text prompt. Further, FIG. 4B includes optimization component 435B. Optimization component 435B is an example of, or includes aspects of, the corresponding element described with reference to FIGS. 2 and 8.

In the example shown, the system obtains an input image as input prompt 400B. In this example, input prompt 400B is an image provided by a user. The system encodes the text using multimodal encoder 405B to generate prompt embedding 410B. When the input prompt 400B is an image, multimodal encoder 405B does not need to find a corresponding image embedding to use as prompt embedding 410B, as prompt embedding 410B is already within an image embedding cluster within the multimodal embedding space.

The process for generation images then proceeds similarly as described with reference to FIG. 4A, except in that the process additionally incorporates optimization component 435B. Optimization component 435B is configured to adjust the weights of generator network 430B based on a ‘pivot’ according to a process known as Pivotal Tuning Inversion (PTI). During this process, mapping network 425B inverts an input image into a latent code. Then, optimization component 435B adjusts parameters of generative network 430B until the output of the generative network 430B matches the input image as closely as possible. In some examples, the optimization component 435B utilizes a loss function that measures the difference between the generated image and the input image to adjust generative network 430B. This process may be considered analogous to throwing a dart (the generation of the latent code) and then moving the target (adjusting the generator) so that it lands on a bullseye. According to some aspects, optimization component 435B performs the PTI process during training. In some aspects, optimization component 435B performs the PTI process using input images during inference as well.

### Generating Abstract Backgrounds

A method for image generation is described. One or more aspects of the method include obtaining an input prompt; encoding the input prompt to obtain a prompt embedding; generating a latent vector based on the prompt embedding and a noise vector using a mapping network of a generative adversarial network (GAN); and generating an image based on the latent vector using the GAN. In some aspects, the GAN is trained to generate abstract images based on conditioning from abstract image embeddings.

In some aspects, the prompt comprises a text prompt describing an abstract design, and the generated image includes the abstract design. In some aspects, the prompt comprises an image depicting a version of an abstract design, and the generated image includes the abstract design. In some aspects, the abstract image embeddings and the prompt embedding are generated using a multimodal encoder.

In some aspects, the input prompt comprises an original image including an abstract design and text describing a modification to the original image, wherein the generated image includes the modification to the original image. In some aspects, the input prompt comprises an original image and text describing an abstract design.

Some examples of the method, apparatus, non-transitory computer readable medium, and system further include performing an image inversion by tuning the GAN using the latent vector as a pivot for a latent space of the GAN. For example, the GAN may be tuned using an optimization component as described with reference to FIG. 4, before image inversions are performed for editing and other downstream tasks.

FIG. 5 shows an example of a method 500 for using the image generation system according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, a user provides an input prompt indicating an abstract design. In one example, the input prompt is “abstract background with crystal structure”. The user may do so through, for example, a user interface as described with reference to FIG. 1. In some cases, the user interface includes a web-app through which the user can access the system. The prompt may be an image or a text.

At operation 510, the system encodes the prompt. The system may encode the prompt using a language based multimodal encoder such as the one described with reference to FIGS. 2 and 4 to generate a prompt embedding. For example, the language based multi-modal encoder may use a pre-trained CLIP model to generate an embedding that represents the visual features associated with the input prompt “abstract background with crystal structure”.

At operation 515, the system generates an abstract background based on the input prompt. For example, the system may use a GAN such as the one described with reference to FIGS. 2 and 4 to generate the abstract background, using the prompt embedding as a condition to the network. For example, the system may generate an image having visual features of abstract background with a crystal structure.

At operation 520, the system provides the image to the user. For example, the system may provide the image to a user via a user interface. The user interface may include a graphical user interface. At this point, the system may prompt the user to edit or regenerate the image.

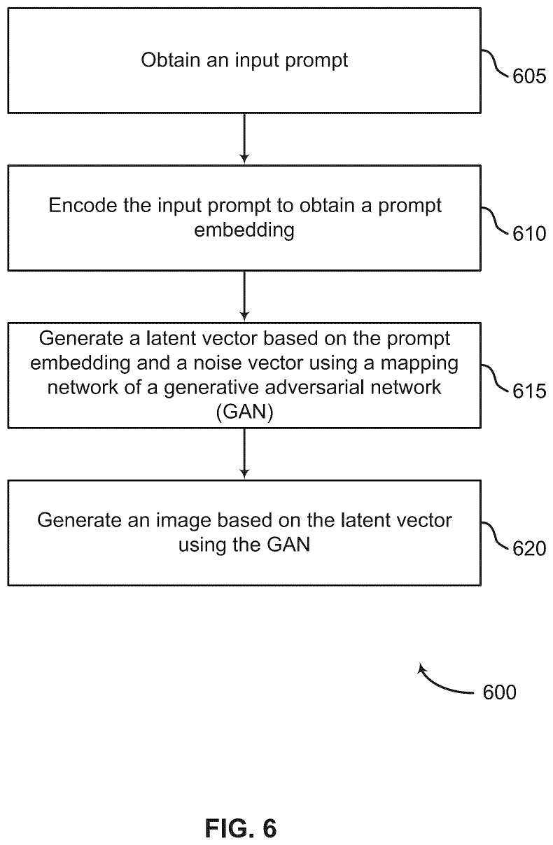

FIG. 6 shows an example of a method 600 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains an input prompt. In some cases, the operations of this step refer to, or may be performed by, an image generation apparatus as described with reference to FIGS. 1 and 2. The input prompt may be provided by a user as described above, or may be provided from another system. For example, the system may be configured automated to reach an end point of another system to obtain many input prompts in sequence as a part of a batch process. In one example, the system automatically extracts an input prompt from a user from a text or image field of a user program, such as a web browser or illustration program, and proceeds with the remaining operations.

At operation 610, the system encodes the input prompt to obtain a prompt embedding. In some cases, the operations of this step refer to, or may be performed by, a multimodal encoder as described with reference to FIGS. 2, 4, and 8.

At operation 615, the system generates a latent vector based on the prompt embedding and a noise vector using a mapping network of a generative adversarial network (GAN). In some cases, the operations of this step refer to, or may be performed by, a mapping network as described with reference to FIGS. 2-4, and 8. In some cases, the latent vector is generated based on an already generated or provided image. For example, the system may invert an image into a latent vector for editing purposes, before generating the image again. In some cases, the system may invert the image into a latent vector for a PTI process as described with reference to FIG. 4.

At operation 620, the system generates an image based on the latent vector using the GAN. In some cases, the operations of this step refer to, or may be performed by, a GAN as described with reference to FIG. 2. The system may use generation process as described with reference to FIGS. 3-4. for generating the image. The system may then present the generated image to a user, and optionally prompt the user to regenerate the image or edit the image.

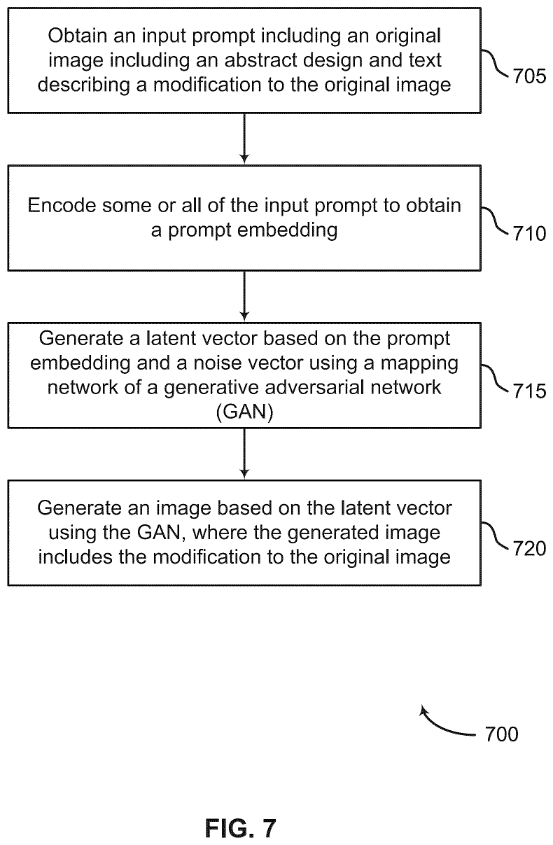

FIG. 7 shows an example of a method 700 for editing an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an input prompt including an original image including an abstract design and text describing a modification to the original image. In some cases, the operations of this step refer to, or may be performed by, an image generation apparatus as described with reference to FIGS. 1 and 2. In some embodiments, the system includes a translation component configured to convert the text describing the modification into a list of attributes and edits thereto.

At operation 710, the system encodes some or all of the input prompt to obtain a prompt embedding. In some cases, the operations of this step refer to, or may be performed by, a multimodal encoder as described with reference to FIGS. 2, 4, and 8.

At operation 715, the system generates a latent vector based on the prompt embedding and a noise vector using a mapping network of a generative adversarial network (GAN). In some cases, the operations of this step refer to, or may be performed by, a mapping network as described with reference to FIGS. 2-4, and 8. In some cases, the latent vector is a representation of the original image and the modification to the original image.

At operation 720, the system generates an image based on the latent vector using the GAN, where the generated image includes the modification to the original image. In some cases, the operations of this step refer to, or may be performed by, a GAN as described with reference to FIG. 2. The system may use generation process as described with reference to FIGS. 3-4. for generating the image. In some cases, the system then presents the modified image to a user, and prompts the user to make further edits or to regenerate the image.

### Training

A method for image generation is described. One or more aspects of the method include obtaining a training image; encoding the training image to obtain an image embedding; and training a generative adversarial network (GAN) to generate a latent vector based on the image embedding and a noise vector, and to generate an output image based on the latent vector. Some examples further include classifying the output image using a discriminator network. Some examples further include computing a discriminator loss based on the classification, wherein the GAN is trained based on the discriminator loss.

Some examples of the method, apparatus, non-transitory computer readable medium, and system further include obtaining training data including abstract background images, wherein the GAN is trained based on the abstract background images. Some examples further include computing a reconstruction loss based on the abstract image and the output image, wherein the GAN is trained based on the reconstruction loss. In some aspects, the reconstruction loss comprises a pixel-based loss term and a perceptual loss term.

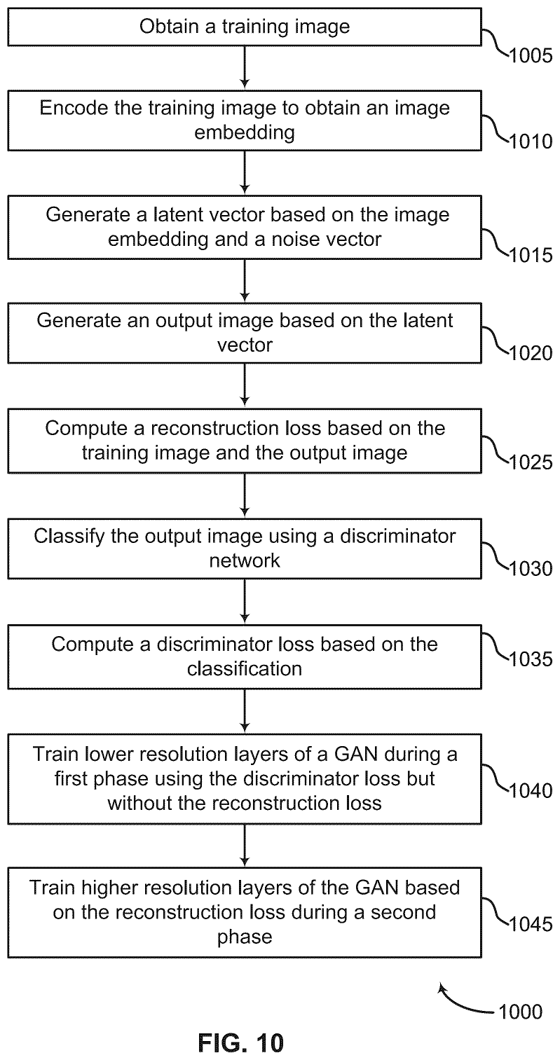

Some examples further include training the GAN during a first phase without the reconstruction loss. Some examples further include training the GAN during a second phase using the reconstruction loss, wherein the second phase trains high resolution layers of the GAN and the first phase trains low resolution layers of the GAN. This case is described with reference to FIG. 10.

FIG. 8 shows an example of an architecture of the GAN during training according to aspects of the present disclosure. The example shown includes training data 800, multimodal encoder 805, training image embedding 810, noise component 815, noise vector 820, mapping network 825, generator network 830, optimization component 835, discriminator network 840, training component 845, and loss function(s) 850.

Multimodal encoder 805 is an example of, or includes aspects of, the corresponding element described with reference to FIGS. 2 and 4. Noise component 815 is an example of, or includes aspects of, the corresponding element described with reference to FIG. 4. Noise vector 820 is an example of, or includes aspects of, the corresponding element described with reference to FIG. 4.

Mapping network 825, generator network 830, and optimization component 835 are examples of, or include aspects of, the corresponding elements described with reference to FIGS. 2-4. Discriminator network 840 and training component 845 are examples of, or include aspects of, the corresponding elements described with reference to FIG. 2.

FIG. 8 illustrates a similar architecture to that shown in FIG. 4, but further includes additional components that are used during training of the GAN. For example, the architecture includes discriminator network 840 and training component 845.

In an example training pipeline, training data 800 including abstract backgrounds is fed to the model. For each training image in the dataset, multimodal encoder 805 embeds the image to generate training image embedding 810. As described above, training image embedding 810 includes a much greater depth of contextual information than the class-conditional information used by conventional GANs during training. For example, a training dataset can include many abstract background images with a high degree of variance. In a conventional GAN, this variety of training backgrounds would all be associated with the class-conditional information label “Abstract Backgrounds”. In contrast, each training image processed by embodiments of the present disclosure will be associated with its own training image embedding 810. In some cases, this allows the trained model to escape mode collapse, and produce abstract background images with high variance.

After generating training image embedding 810, the model combines the embedding with noise vector 820 generated by noise component 815. This combination is applied to mapping network 825, which uses several fully connected layers to generate a latent vector in a latent space based on both training image embedding 810 and noise vector 820.

Next, generator network 830 generates an output image from the latent vector. The generation process may be the same or similar to the process as described with reference to FIGS. 3-4. In some cases, generator network 830 utilizes progressive growing, in which generator network 830 generates progressively larger images. For example, in a first stage, the generator may produce a four pixel 2×2 “image”, which discriminator network 840 evaluates against a downsampled 2×2 real “image”. In subsequent stages, generator network 830 generates images of higher resolution such as 512×512 or 1024×1024.

In some cases, training component 845 computes a loss based on the output image from generator network 830. For example, training component 845 may compute loss function(s) 850 based on differences between the output image and the input image from training data 800, even before the output image is evaluated by discriminator network 840. In some examples, training component training component 845 computes L2 and LPIPS losses based on these differences. These losses can be referred to as “reconstruction losses”. The reconstruction loss may be the difference between the generated output image and the original abstract background image used as training data 800. In some examples, the reconstruction loss may be computed based on the abstract image and the output image. In some cases, the reconstruction loss includes a pixel-based loss term and a perceptual loss term. In some cases, the reconstruction loss is used during the second phase of training, which focuses on training the high resolution layers of the GAN, whereas the first phase trains the low resolution layers without the reconstruction loss.

The pixel-based loss term measures the difference between the generated image and the target image at the pixel level. For example, a pixel-based loss term may use metrics such as Mean Squared Error (MSE) or Mean Absolute Error (MAE), which calculate the difference between the pixel values of the generated image and the target image. The perceptual loss term measures the perceptual similarity between the generated image and the target image by taking into account high-level features such as texture, structure, and style. In some examples, the perceptual loss term may be computed using pre-trained deep neural networks to extract these high-level features. According to some embodiments, a L2 loss is a pixel-based loss term and a LPIPS loss is a perceptual loss term. In some cases, the L2 and LPIPS losses are computed during the higher resolution stages for generator network 830, and not for the lower resolution stages.

Discriminator network 840 evaluates output images from generator network 830. For embodiments of generator network 830 that include progressive growing, i.e., generating images at different resolution levels, discriminator network 840 may evaluate the output images at each resolution level. In some cases, discriminator network 840 classifies the output image as ‘real’ or ‘fake’ (generated), and training component 845 computes a loss based on this classification. This loss can be referred to as a “classification loss” and can be included in loss function(s) 850. In some embodiments, discriminator network 840 includes multiple discriminator components configured to evaluate output images on different bases, such as fine or coarse features, “identity”, or others. Embodiments of discriminator network 840 are further configured to evaluate whether or not the output image is relevant to training image embedding 810. In this way, training image embedding 810 is used to condition both generator network 830 and discriminator network 840 during training.

Optimization component 835 is the same as, or includes aspects of, the optimization component described with reference to FIG. 4. Embodiments of optimization component 835 are configured to perform PTI based on a pivot code. In some cases, training image embedding 810 is used directly as a pivot code. For example, during a PTI process, optimization component 835 adjusts parameters of generator network 830 so that generator network 830 produces the input training image as closely as possible based on training image embedding 810. In some cases, during this PTI tuning process, noise vector 820 is not used, thereby tuning generator network 830 to produce the training image as closely as possible based on training image embedding 810 only.

Accordingly, the pipeline described above trains a GAN of the present disclosure to learn to reproduce abstract images. Specifically, parameters of the GAN are updated end-to-end during a training process that includes conditioning from multimodal embeddings of training images, rather than class-conditional information. Once the model is trained, a user may provide a prompt which will be embedded by the multimodal encoder, and corresponded within the learned latent space of the GAN to features from the training data. The GAN may then generate diverse output images that include visual features from the prompt.

Embodiments are not necessarily restricted to learning abstract images. In some embodiments, the training data includes images from other domains, e.g. domains that may have a large variety of detail within a single class-conditional label.

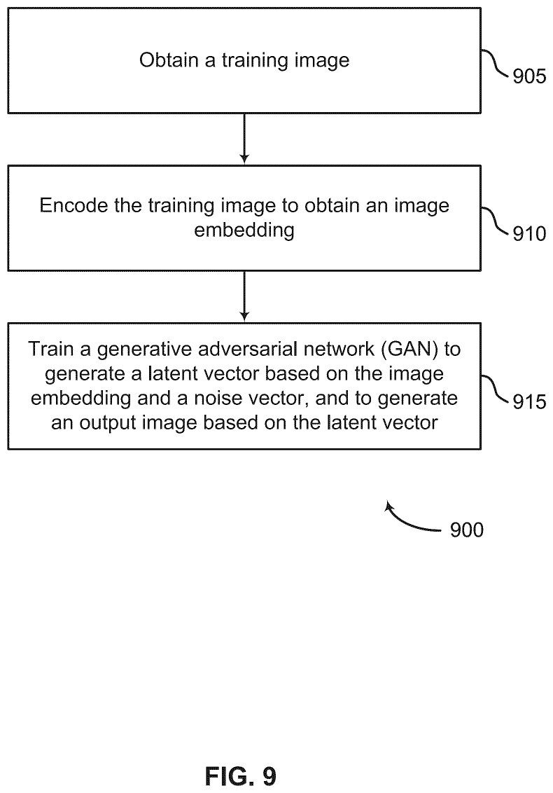

FIG. 9 shows an example of a method 900 for training a generative image model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains a training image. In some cases, the operations of this step refer to, or may be performed by, an image generation apparatus as described with reference to FIGS. 1 and 2. In some examples, the training image is one of several training images from a training dataset.

At operation 910, the system encodes the training image to obtain an image embedding. In some cases, the operations of this step refer to, or may be performed by, a multimodal encoder as described with reference to FIGS. 2, 4, and 8. Embodiments of the multimodal encoder include a pre-trained language based encoder. In at least one embodiment, the multimodal encoder is a CLIP network, and the image embedding is a CLIP embedding.

At operation 915, the system trains a GAN to generate a latent vector based on the image embedding and a noise vector, and to generate an output image based on the latent vector. In some cases, the operations of this step refer to, or may be performed by, a training component as described with reference to FIGS. 2 and 8. For example, the GAN may be trained in a process similar to the pipeline described with reference to FIG. 8.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. The method 1000 is similar to the method described with reference to FIG. 9, but provides further detail regarding the loss functions used during training.

At operation 1005, the system obtains a training image. In some cases, the operations of this step refer to, or may be performed by, an image generation apparatus as described with reference to FIGS. 1 and 2. In some examples, the training image is one of several training images from a training dataset.

At operation 1010, the system encodes the training image to obtain an image embedding. In some cases, the operations of this step refer to, or may be performed by, a multimodal encoder as described with reference to FIGS. 2, 4, and 8. In at least one embodiment, the multimodal encoder is a CLIP network, and the image embedding is a CLIP embedding.

At operation 1015, the system generates a latent vector based on the image embedding and a noise vector. In some cases, the operations of this step refer to, or may be performed by, a mapping network as described with reference to FIGS. 2-4, and 8.

At operation 1020, the system generates an output image based on the latent vector. For example, a GAN may apply learned transformations to the latent vector, which is in a latent “W” space, to yield data in another space such as a pixel or image space.

At operation 1025, the system computes a reconstruction loss based on the training image and the output image. In some cases, the operations of this step refer to, or may be performed by, a training component as described with reference to FIGS. 2 and 8. The reconstruction loss may be based on differences in the pixel data from the training image and the output image. In some cases, the reconstruction losses are computed at different resolutions. For example, the reconstruction losses may be computed for 256×256 and 512×512 output images, though the present disclosure is not limited thereto.

At operation 1030, the system classifies the output image using a discriminator network. For example, a discriminator network may evaluate the output image according to the methods described with reference to FIG. 8. In some cases, the discriminator network evaluates the output image on several different bases, including the output image's relevance to the latent vector.

At operation 1035, the system computes a discriminator loss based on the classification. In some examples, the discriminator loss includes multiple values that correspond to different types of evaluations.

At operation 1040, the system trains lower resolution layers of a GAN during a first phase using the discriminator loss but without the reconstruction loss. In some cases, the operations of this step refer to, or may be performed by, a training component as described with reference to FIGS. 2 and 8. In this example, the system may adjust parameters of the GAN that are configured to produce output images at lower resolutions based on the classification loss from the discriminator, but not necessarily on the reconstruction loss.

At operation 1045, the system trains higher resolution layers of the GAN based on the reconstruction loss during a second phase. In an example, the system trains higher resolution layers of the GAN based on both the reconstruction loss and the classification loss during this phase.

This method describes an example in which different losses are applied during different phases of training in one particular way, but the present disclosure is not limited thereto. For example, in some cases, one or more parameters of the system may be held fixed while others are adjusted during different training phases.

FIG. 11 shows an example of a computing device 1100 according to aspects of the present disclosure. The example shown includes computing device 1100, processor(s), memory subsystem 1110, communication interface 1115, I/O interface 1120, user interface component(s), and channel 1130.

In some embodiments, computing device 1100 is an example of, or includes aspects of, image generation apparatus 100 of FIG. 1. In some embodiments, computing device 1100 includes one or more processors 1105 that can execute instructions stored in memory subsystem 1110 to obtain an input prompt; encode the input prompt to obtain a prompt embedding; generate a latent vector based on the prompt embedding and a noise vector using a mapping network of a GAN; and generate an image based on the latent vector using the GAN.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote control device interfaced with a user interface directly or through the I/O controller), or a combination thereof. In some cases, user interface component(s) 1125 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt;
encoding the input prompt to obtain a prompt embedding;
generating a latent vector based on the prompt embedding and a noise vector using a mapping network of a generative adversarial network (GAN); and
generating an image based on the latent vector using the GAN.

2. The method of claim 1, wherein:
the prompt comprises a text prompt describing an abstract design.

3. The method of claim 1, wherein:
the prompt comprises an image depicting an abstract design.

4. The method of claim 1, wherein:
the GAN is trained to generate abstract images based on conditioning from abstract image embeddings.

5. The method of claim 4, wherein:
the abstract image embeddings and the prompt embedding are generated using a multimodal encoder.

6. The method of claim 1, further comprising:
performing an image inversion by tuning the GAN using the latent vector as a pivot for a latent space of the GAN.

7. The method of claim 1, wherein:
the input prompt comprises an original image including an abstract design and text describing a modification to the original image.

8. The method of claim 1, wherein:
the input prompt comprises an original image and text describing an abstract design.

9. A method comprising:
obtaining a training image;
encoding the training image to obtain an image embedding;
generating a latent vector for a generative adversarial network (GAN) based on the image embedding using a mapping network; and
training the GAN to generate an output image based on the latent vector using a discriminator network.

10. The method of claim 9, further comprising:
obtaining training data including abstract background images, wherein the GAN is trained based on the abstract background images.

11. The method of claim 10, further comprising:
classifying the output image using the discriminator network; and
computing a discriminator loss based on the classification, wherein the GAN is trained based on the discriminator loss.

12. The method of claim 10, further comprising:
computing a reconstruction loss based on an abstract image from the abstract background images and a predicted image, wherein the GAN generates the predicted image and is trained based on the reconstruction loss.

13. The method of claim 12, wherein:
the reconstruction loss comprises a pixel-based loss term and a perceptual loss term.

14. The method of claim 12, further comprising:
training the GAN during a first phase without the reconstruction loss; and
training the GAN during a second phase using the reconstruction loss, wherein the second phase trains high resolution layers of the GAN and the first phase trains low resolution layers of the GAN.

15. An apparatus comprising:
at least one processor;
at least one memory storing instructions executable by the processor; and
a generative adversarial network (GAN) comprising parameters stored in the at least one memory, wherein the GAN is trained to generate a latent vector based on an image embedding and a noise vector, and to generate an output image based on the latent vector.

16. The apparatus of claim 15, wherein:
the GAN comprises a mapping network and a generator network, wherein the mapping network is configured to generate the latent vector for input to the generator network.

17. The apparatus of claim 16, further comprising:
an optimization component configured to tune the GAN using the latent vector as a pivot for a latent space of the GAN.

18. The apparatus of claim 15, further comprising:
a multimodal encoder configured to generate the image embedding based on an input image or an input text.

19. The apparatus of claim 15. further comprising:
a discriminator network configured to classify an output of the GAN.

20. The apparatus of claim 15. further comprising:
a training component configured to train the GAN based on a reconstruction loss. wherein the reconstruction loss is computed based on the output image.
